(19) United States
(12) Patent Application Publication
(10) Pub. No.: US 2025/0365073 A1
(43) Pub. Date: Nov. 27, 2025

(54) DYNAMIC RING ASSIGNMENT FOR DENSE WAVE DIVISION MULTIPLEXING SYSTEMS

(71) Applicant: NVIDIA Corp., Santa Clara, CA (US)

(72) Inventors: Sanquan Song, Los Altos Hills, CA (US); Nikola Nedovic, San Jose, CA (US); Thomas Hastings Greer III, Chapel Hill, NC (US); Carl Thomas Gray, Apex, NC (US)

(73) Assignee: NVIDIA Corp., Santa Clara, CA (US)

(21) Appl. No.: 19/039,016

(22) Filed: Jan. 28, 2025

Related U.S. Application Data
(60) Provisional application No. 63/650,137, filed on May 21, 2024.

(51) Int. Cl. H04B 10/50; G02B 6/12; H01S 3/083; H04B 10/572

(52) U.S. Cl. CPC H04B 10/503; G02B 6/12009; H01S 3/083; H04B 10/572

(57) ABSTRACT

Mechanisms for tuning the optical resonator rings in an optical transmitter or an optical receiver involves reassigning one or more of the optical resonator rings to different laser lines, wherein the reassignment is based on mitigating an impact on energy consumption from adding or removing heat from the optical resonator rings to bring their resonant wavelengths coincident with the laser lines.

### CROSS REFERENCE TO RELATED APPLICATIONS

This application claims priority and benefit under 35 U.S.C. 119 (e) to U.S. Application Ser. No. 63/650,137, “Dynamic ring assignment for DWDM systems”, filed on May 21, 2024, the contents of which are incorporated herein by reference in their entirety.

### BACKGROUND

The optical rings utilized in Dense Wave Division Multiplexing (DWDM) optical systems may each have an applied heating element configured to shift the resonant wavelengths of the rings to closely match the dominant spectral peaks (e.g., laser lines) of light sources on an optical waveguide. By applying heat to the rings in an optical transmitter for example, the resonant wavelengths may be shifted relative to provide the needed signal power and to maintain sufficient spacing between channels to avoid interference and distortion. However the use of heaters comes at the cost of higher power consumption. Greater resonant wavelength shifts may require more applied heat and hence consume more power.

In a typical DWDM system the spacing between adjacent wavelengths may be a fraction of one free spectral range of the utilized rings. Therefore shifting the resonant wavelength of one ring may necessitate shifting the resonant wavelength of an adjacent ring along the optical waveguide (assuming the resonant wavelengths of the rings are ordered along the optical waveguide according to the spectral ordering of the laser lines). This successive shifting may be needed to avoid constricting the distance between the two adjacent resonant wavelengths to an extent that results in excessive interference between them on the light guide.

When the resonant wavelength of a particular ring is shifted to a large extent (e.g., by a large fraction of the ring's FSR), it may cause a chain reaction in which a number of other rings also must be heated to shift their wavelengths by similar amounts. As noted above, the application of more heat comes at the cost of higher power consumption.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a dense wave division multiplexed (DWDM) transceiver in one embodiment.

FIG. 2 depicts an example of tuning the resonant wavelength an optical resonator ring through one free spectral range.

FIG. 3A depicts an example of an optical resonator ring with a small heating shift applied to move the resonant wavelength to the next laser line.

FIG. 3B depicts an example of an optical resonator ring in which a 0.125 free spectral range shift is applied to move the resonant wavelength to the next laser line.

FIG. 3C depicts an example of an optical resonator ring in which a nearly 0.25 free spectral range shift is applied to move the resonant wavelength to the next laser line.

FIG. 4 depicts an embodiment of an optical receiver utilizing a pair of clock distribution lines.

FIG. 5 illustrates an aspect of the subject matter in accordance with one embodiment.

FIG. 6 illustrates an aspect of the subject matter in accordance with one embodiment.

FIG. 7 depicts an embodiment of an optical receiver utilizing four waveguides for clock distribution.

FIG. 8 depicts a dynamic wavelength re-assignment process in accordance with one embodiment.

FIG. 9 depicts a dynamic wavelength re-assignment process in accordance with another embodiment.

FIG. 10 depicts a dynamic wavelength re-assignment process in accordance with another embodiment.

### DETAILED DESCRIPTION

Free Spectral Range (FSR) in the context of optical resonators refers to the frequency or wavelength interval between resonant peaks or modes of the resonator's optical cavity. The free spectral range of the optical the rings utilized in a DWDM system determines the maximum number of optical channels that may be accommodated within an available bandwidth.

In DWDM systems, data is transmitted over multiple optical carrier frequencies (wavelengths) closely spaced within the fiber. A larger ring free spectral range may accommodate more channels, thus increasing the system's data-carrying capacity. Proper selection and utilization of the free spectral range is important to avoid inter-channel crosstalk. Crosstalk occurs when signals in adjacent spectral channels interfere with each other, potentially degrading the signal quality. Proper selection and utilization of the free spectral range and inter-channel spacing helps ensure that each channel is cleanly separated from the others, reducing the likelihood of interference and signal distortion.

Disclosed herein are embodiments of dynamic ring assignment mechanisms for DWDM systems, wherein the optical rings are dynamically (in response to extant operating conditions) reassigned to different laser lines such that, on average, the resonant wavelength of each optical ring is thermally tuned (via application of more or less heat) to an extent that overall reduces energy consumption over conventional approaches.

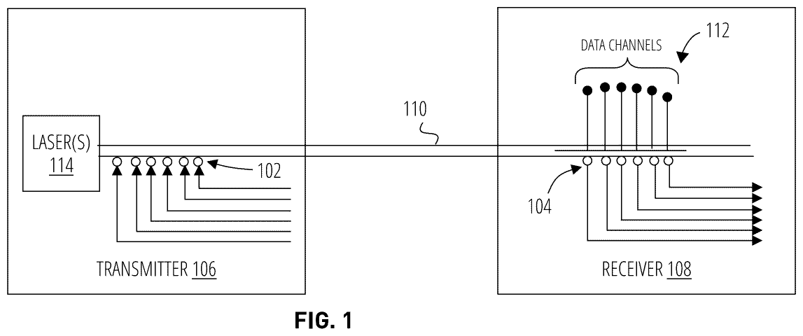

FIG. 1 depicts a dense wave division multiplexed (DWDM) transceiver in one embodiment. The transceiver a comprises a transmitter 106 coupled to a receiver 108 over a waveguide 110. The data channels of the optical spectrum 112 are centered on laser lines (the peaks in the optical spectrum 112 generated by a laser source 114 (e.g., multiple discrete lasers or a comb laser) and are modulated with data signals using resonant rings 102 (e.g., micro-ring modulators) at the transmitter end of the waveguide 110. The data channels in the optical spectrum 112 are demultiplexed by resonant rings 104 (e.g., micro-ring resonant filters) at the receiver 108.

A micro-ring modulator and a micro-ring resonant filter (also called a ‘drop ring’) are both devices that exploit the resonant properties of optical resonators but serve different purposes in optical systems. A micro-ring modulator is a device used to modulate the intensity, phase, or frequency of light passing through it, based on the input electrical signals. It incorporates a micro-ring resonator next to a waveguide. When light enters the system, part of it couples into the micro-ring and interferes with incoming light. By applying an electrical signal, the refractive index of the micro-ring is changed, altering the resonant condition of the ring. This modulation affects how much light is transmitted through the waveguide, allowing the micro-ring modulator to encode information onto an optical signal for applications in optical communication systems.

Micro-ring resonant filters, on the other hand, are designed to selectively transmit or drop specific wavelengths of light. These devices utilize a micro-ring resonator coupled to one or more waveguides. Light traveling through the waveguide interacts with the micro-ring; only wavelengths that match the resonant condition of the ring can efficiently couple into and circulate within the ring, being either dropped to another waveguide or removed from the main waveguide, thereby filtering out specific wavelengths.

Each of the resonant rings 102 may be assigned to modulate data onto a different laser line, and each of the resonant rings 104 may be tuned to a filter and drop the signal modulated on a particular one of the laser lines. The corresponding resonant rings in the transmitter 106 and the receiver 108 may have their resonant frequencies locked and matched in a closed-loop control circuit to track any shifts in the laser line's wavelength due to temperature drift or other factors.

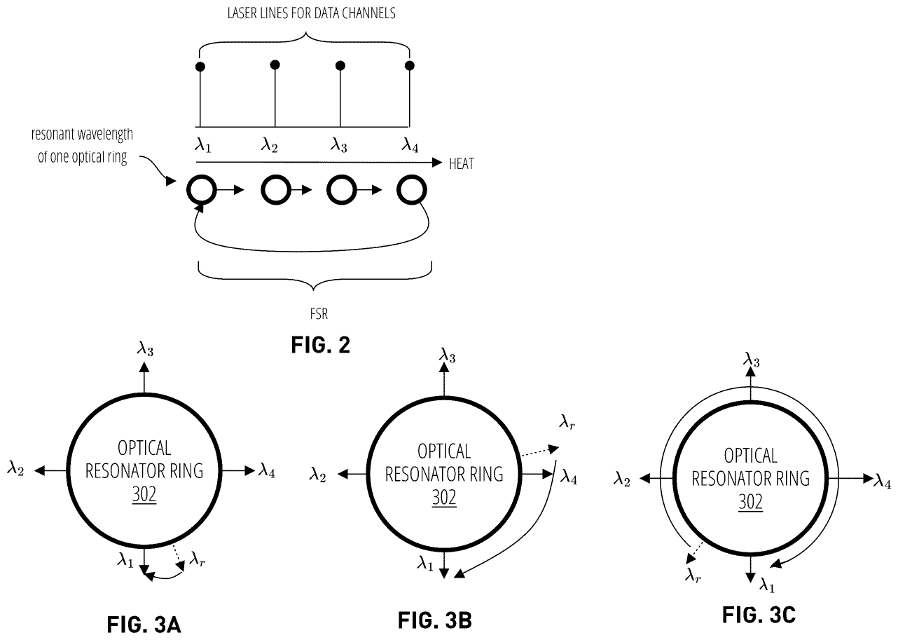

FIG. 2 depicts an example of tuning the resonant wavelength an optical resonator ring through one free spectral range. The optical resonator ring resonates at the wavelength of the input light when the length of its internal optical waveguide is an integer multiple of the input light wavelength. The optical resonator ring outputs a peak power intensity of the light at its resonant wavelength. Altering the properties of the internal light guide of the optical resonator ring, for example by heating it up, alters the resonant wavelength of the optical resonator ring. If an unheated resonant ring resonates at wavelength λ₁, and enough heat is applied to move the ring through its entire free spectral range, the resonant wavelength of the optical resonator ring will cycle back to the resonant wavelength λ₁ before heat was applied.

In practice, resonant rings often require calibration in order for their resonant wavelength to align with a laser line. Calibration of an optical resonator ring in a DWDM system typically involves applying some amount of heat to the ring to shift its resonant wavelength as close as practical to the peak power wavelength (e.g., laser line) of one of the light sources on the DWDM optical waveguide. Unacceptable crosstalk between optical channels can occur when the resonant wavelength of two or more optical resonator rings on the DWDM waveguide are shifted too close to one another during calibration.

FIG. 3A depicts an example of an optical resonator ring with a small amount of heating energy applied to tune the ring's resonant wavelength from its current value λᵣ to the laser line wavelength λ₁ to which the ring is assigned.

FIG. 3B depicts an example of an optical resonator ring with a larger amount of heating energy applied to tune the ring's resonant wavelength from its current value λᵣ to the laser line wavelength λ₁ to which the ring is assigned. The total shift amounts to a substantial portion of the rings' free spectral range, and it may be more energy-efficient to re-assign the ring to resonate at laser line wavelength λ₄.

FIG. 3C depicts an example of an optical resonator ring with a very larger amount of heating energy applied to tune the ring's resonant wavelength from its current value λᵣ to the laser line wavelength λ₁ to which the ring is assigned. The total shift amounts to almost the entirety of the rings' free spectral range, and it may be more energy-efficient to re-assign the ring to resonate at laser line wavelength λ₂.

This situation may occur for example if, at ambient room temperature with no heat applied, the rings (or some of them) are tuned slightly above the laser lines assigned to those rings. Because ring cooling mechanisms may be challenging and/or undesirable to implement in practice, heating becomes the only option for tuning the rings to the nearest laser lines, and a substantial amount of heat (and hence, power consumption) is involved to shift the resonant wavelengths through a large fraction of the free spectral range to the laser lines.

By way of example, consider an (8+1)λ DWDM transmitter utilizing eight wavelengths for transmitting data and one wavelength to forward an optical transmitter clock signal to the optical receiver. In such a system, a desired channel spacing may be 13.6 nm/9=1.51 nm, where 13.6 nm is the available optical band.

In one example scenario, the optical resonator rings in this system operate with an upward shift of 0.75 nm in their resonant wavelengths to coincide with the laser lines, and the ambient temperature begins to increase. The optical waveguides of the optical resonator rings will begin to respond to the rise in ambient temperature. Because cooling is not available, heating may be applied to recalibrate the optical waveguides of the rings by shifting the resonant wavelengths further clockwise around the free spectral range (see FIG. 2). The shift needed to maintain the resonant wavelengths of the rings at the laser lines may comprise a large fraction of the rings' free spectral range and the corresponding increase in energy consumption may be substantial.

In another example scenario, the optical resonator rings in the system are again initially operating with an upward shift of 0.75 nm to match the laser lines. However in this scenario the ambient temperature of the system begins to decrease. Heat may then be applied to each ring to maintain the output wavelengths at nominal settings. If the ambient temperature continues to drop, more and more heat must be applied to maintain the resonant wavelengths of the rings coincident with the laser lines.

In either scenario, rather than trying to maintain a fixed assignment of each ring to one of the laser lines by applying more and more heat, it may be more energy efficient to change the assignment of which rings along the DWDM waveguide resonate with which laser lines.

Calibration logic 404 may be utilized to perform dynamic wavelength re-assignment between laser line wavelengths and the optical resonator rings in the transmitter, the receiver, or both.

One embodiment of dynamic wavelength re-assignment involves taking all rings of a DWDM transmitter offline at once, shifting the resonant wavelength of each ring to the nearest (in energy impact terms) laser line, and then placing all the rings back online. This approach is relatively straightforward and fast. It does not utilize spare optical resonator rings. However, it generates a shock to the overall system data throughput. The throughput drops to zero for the time it takes to perform the dynamic wavelength re-assignment and bring the system back to operation.

Another embodiment utilizes one or more spare optical resonator rings. This approach is described in more detail below. Yet another embodiment does not utilize spare optical resonator rings and takes some number of optical resonator rings (less than all of them) offline during the re-assignment process. This approach is also described in more detail below. This approach balances the overall hit to system throughput against higher complexity and reduced completion speed.

The implementation of the third approach varies depending on whether or not the system utilizes a forwarded transmitter clock.

In optical systems that do not implement transmitter clock forwarding, dynamical ring assignment to laser lines may be carried out in different manners. In one embodiment in which no spare rings are utilized, the resonant wavelengths of the rings may be tuned (via thermal shifting) to align with laser lines sequentially, in an order determined by the physical location of the rings along the waveguide. Ring assignment to laser lines in these systems may begin with the ring furthest upstream (the ring closest to the laser sources) and conclude with the ring furthest downstream along the waveguide.

A first ring to tune may be taken offline (made inactive), and a second ring may be identified that is sequential in the laser line spectral order to the first ring taken offline. This second ring may also be taken offline, and the first ring's resonant frequency may be tuned to the laser line that was assigned to the second ring before the first ring is re-activated on the waveguide. In some embodiments the first ring taken offline is the ring on the waveguide closest to the laser sources.

This approach helps ensure that the laser line to re-assign to a ring is available and not assigned to a different ring before the ring's resonant wavelength is thermally shifted. With this approach exactly three rings are taken offline during the reassignment process.

In one embodiment in which one spare ring is utilized, the resonant wavelengths of the rings may be shifted in an order determined by the spectrum location of nearest (in energy impact terms) laser line. First, one of the rings is taken offline (made inactive as a channel) by it to an unused wavelength. This ring becomes the new spare ring. A new laser line is selected for the spare ring. The spare ring is tuned to this laser line wavelength and made active on the waveguide. This process is repeated for each ring that needs reassigning. In the worst case this process results in a single ring being offline at a time.

More specifically, the laser line wavelength that the spare ring is tuned to is nearest (in energy budget) to the wavelength that the de-activated ring was tuned to. This process is repeated for the other rings in the transmitter.

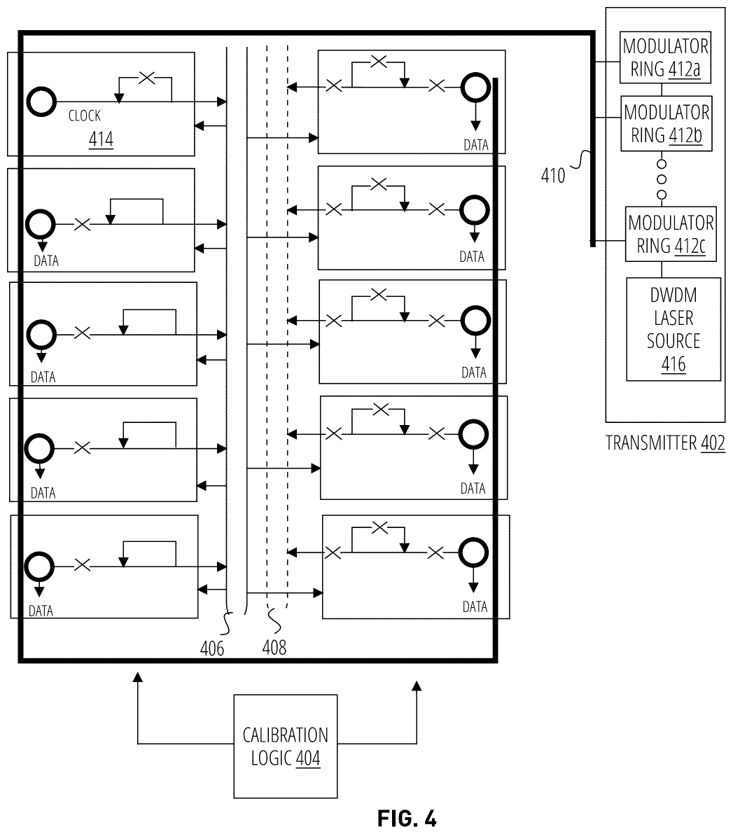

For systems utilizing a forwarded clock, more elaborate mechanisms may be implemented. FIG. 4 depicts an initial state of an 8+1 clock-forwarding optical receiver before optical resonator ring reassignment. In the initial state, the optical resonator ring on receiver lane 414 is tuned to resonate at a wavelength that carries a forwarded clock signal from the optical transmitter 402 on the optical waveguide 410. The forwarded clock is distributed to the 8 data-receiving lanes over electrical conductor 406, forming an injection-locked oscillator. The data-receiving lanes receive data signals encoded onto the optical waveguide 410 by the modulator rings 412a . . . 412c at the laser line frequencies generated by the DWDM laser source 416.

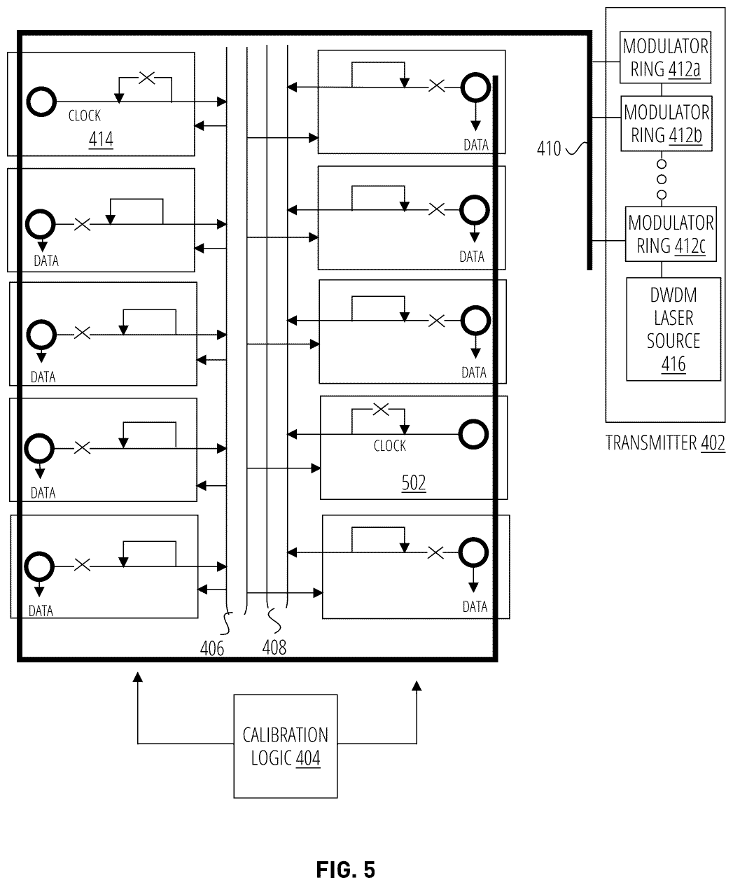

FIG. 5 depicts a state of the optical receiver following the initial state depicted in FIG. 4. Calibration logic 404 may be activated to effectuate the following actions at the transmitter 402 and the receiver.

The transmitter 402 may begin to forward the clock signal over the optical waveguide 410 on two different laser line channels. At the receiver, the optical resonator rings in both of receiver lane 414 and receiver lane 502 are tuned to resonate at the two distinct wavelengths carrying the forwarded clock signal. The forwarded clock signal from receiver lane 414 continues to be distributed to the remaining seven lanes receiving data over the optical waveguide 410 and these receiver lanes continue to receive data from the transmitter 402. The forwarded clock signal on receiver lane 502 is driven onto electrical conductor 408 but not yet switched to clock any of the data-receiving lanes. Another injection-locked oscillator is formed on the electrical conductor 408. A loss of ⅛ of the total data bandwidth is thus incurred at this state of the system.

The receiver lane 502 to receive a second version of the forwarded clock is selected such that the resonant wavelength of the ring on receiver lane 502 is separated (as close as practical) from the resonant wavelength of the ring on receiver lane 414 by one-half of the rings' free spectral range. A backchannel (e.g., one of the data-receiving lanes) between the transmitter 402 and the receiver may be utilized to coordinate the use of the second receiver lane 502 for the forwarded clock. Optical and/or electrical components known in the art (not depicted) may be utilized to phase-align the two forwarded clock signals.

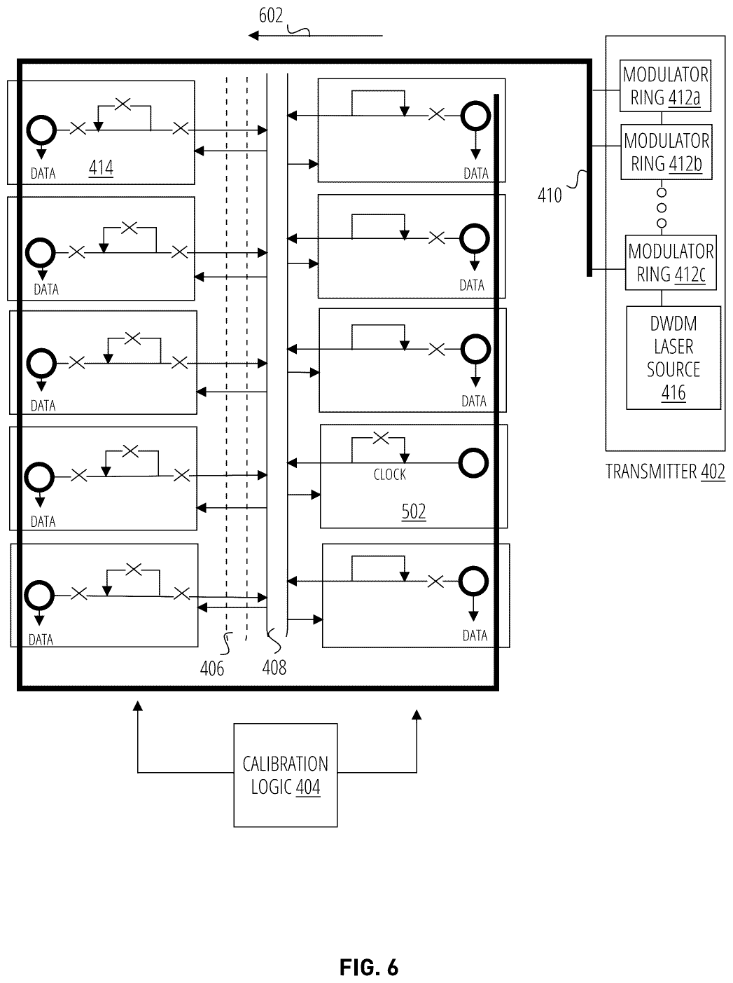

FIG. 6 depicts a state of the optical receiver following the state depicted in FIG. 5. One embodiment of a process for calibrating optical resonator rings in receivers utilizing a forwarded transmitter clock begins with the first ring in receiver lane 414 along the optical waveguide 410 (the ring closest to the transmitter 402). Because this ring is assigned to receive the forwarded clock, receiver lane 414 is deactivated at substantially the same time as the seven active data lanes are switched to receive the redundantly forwarded clock from receiver lane 502, which is already resonating on alternate electrical conductor 408. The optical resonator ring on receiver lane 414 is now ready for re-assignment to one of the data-carrying laser lines. Because only a single optical resonator ring is offline at any time, or used for redundant transmission of the receiver clock, the impact on data throughput throughout this process is ⅛ of total transmitter-to-receiver data bandwidth.

The re-assignment of the first optical resonator ring along the optical waveguide 410 may necessitate a re-assignment of one or more additional downstream (from the transmitter 402) optical resonator rings. Re-assignment of these rings may proceed from one ring to the next adjacent ring in a direction 602 starting with the ring for receiver lane 414 nearest the transmitter 402 along the optical waveguide 410.

Once the ring re-assignment process reaches receiver lane 502, the forwarded clock may be re-assigned again to one of the rings preceding (closer to the transmitter 402) the receiver lane 502 along the optical waveguide 410.

As noted above, in this process only a single optical resonator ring at a time need be offline at any given time during the re-assignment process. At the transmitter 402 side, re-assignment of modulator rings 412a . . . 412c to laser lines may begin with the most-upstream ring (ring closest to the DWDM laser source 416) along the optical waveguide 410. Each ring is shifted (either by adding or removing heat) to whichever laser line involves utilizing the least amount of power to implement the shift. As this process proceeds, if the re-assignment is for the laser line carrying the forwarded clock, the forwarded clock is moved to a different laser line and hence to a different ring/data lane.

If no spare rings are utilized in the transmitter 402, this process necessitates that three rings are not transmitting data at times, which negates somewhat the efficiency of the receiver process, which only involves downtime for a single data lane at a time. Therefore, it may be advantageous in some embodiments to utilize one or two spare rings at least on the transmitter 402 side to maintain throughput.

The process depicted in FIG. 4-FIG. 6 leverages a situation in which the physical ordering of the resonant wavelengths of the optical resonator rings along the optical waveguide 410 at both transmitter 402 and the receiver follows the spectral order of the laser lines generated by the DWDM laser source 416 (e.g., in ascending or descending wavelength order). If the physical locations of the rings along the optical waveguide 410 differs from this ordering, the rings may be re-assigned to based on the spectral ordering. There are a variety of mechanisms to determine the spectral ordering, such as individually heating each ring to measure the crosstalk impact this generates with the outputs of the other rings.

The disclosed dynamic wavelength re-assignment mechanisms are applicable to receivers utilizing more than two injection-locked oscillators, and/or to receivers with uneven distribution of optical resonator rings on the waveguides implementing the injection-locked oscillators.

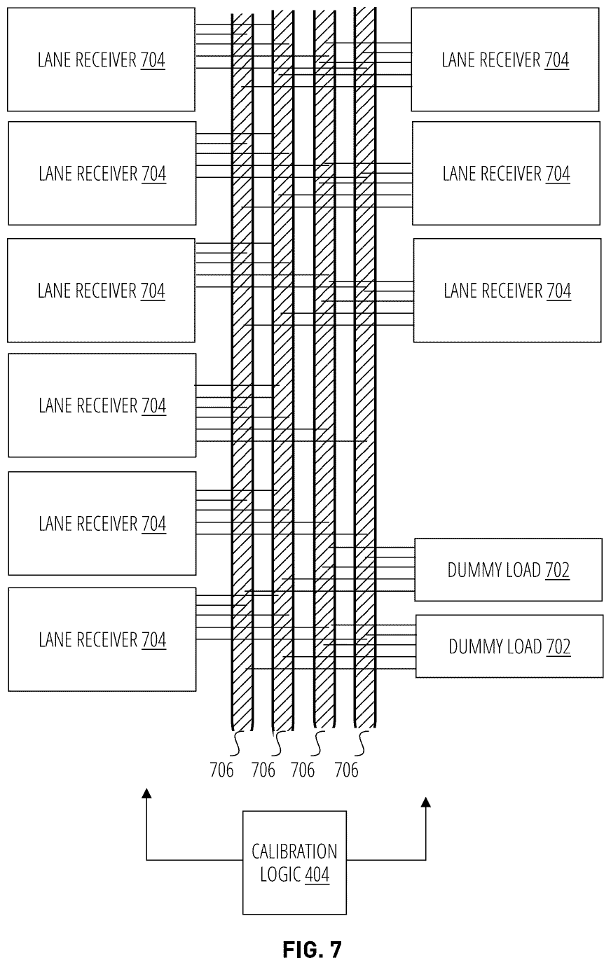

FIG. 7 depicts an example of such a receiver. The various lane receivers 704 for data and for the forwarded clock are coupled to a clock distribution network with four electrical conductors 706. Additional dummy loads 702 may be provided to enable the uniform four-way distribution of loading on the clock distribution network.

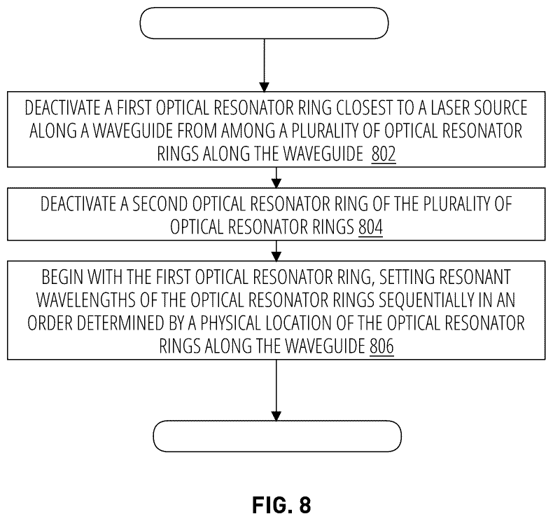

FIG. 8 depicts a dynamic wavelength re-assignment process in accordance with one embodiment. In block 802, a first optical resonator ring closest to a laser source along a waveguide is deactivated (meaning it is suspended as a channel). In block 804, a second optical resonator ring of the plurality of optical resonator rings is also deactivated. In block 806, beginning with the first optical resonator ring along the waveguide, resonant wavelengths of the optical resonator rings are set sequentially in an order determined by a physical location of the optical resonator rings along the waveguide.

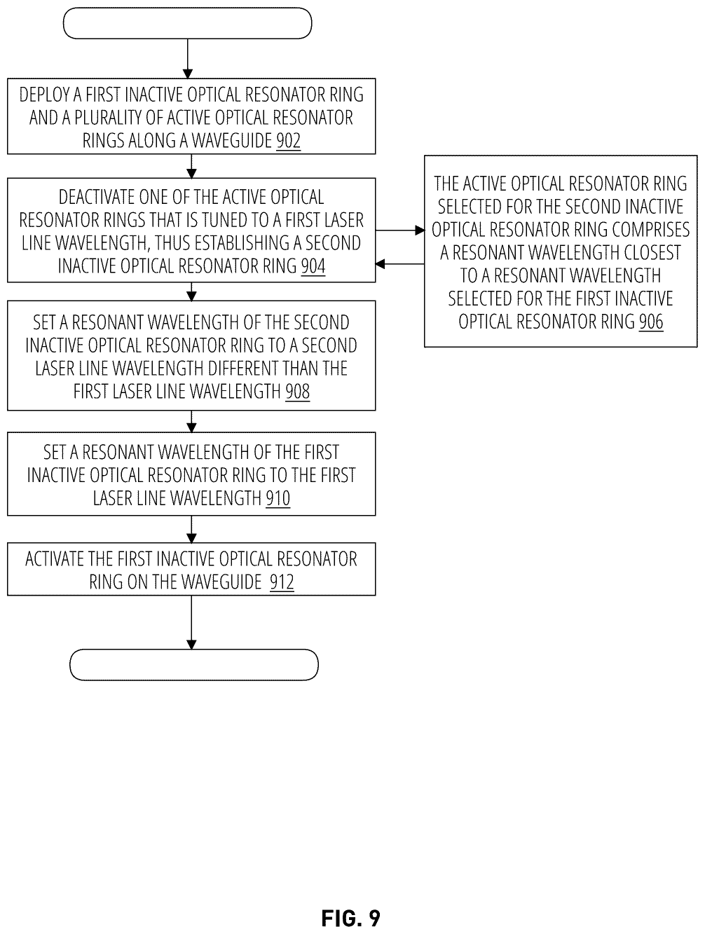

FIG. 9 depicts a dynamic wavelength re-assignment process in accordance with another embodiment. In block 902, a first inactive optical resonator ring and a plurality of active optical resonator rings (optical rings communicating data or clock signals) are deployed along a waveguide. In block 904, one of the active optical resonator rings that is tuned to a first laser line wavelength is deactivated, thus establishing a second inactive optical resonator ring. In block 908, a resonant wavelength of the second inactive optical resonator ring is set to a second laser line wavelength different than the first laser line wavelength. In block 910, a resonant wavelength of the first inactive optical resonator ring is set to the first laser line wavelength. In block 912, the first inactive optical resonator ring is activated on the waveguide. The active optical resonator ring selected for the second inactive optical resonator ring is the one having a resonant wavelength closest to a resonant wavelength selected for the first inactive optical resonator ring (block 906).

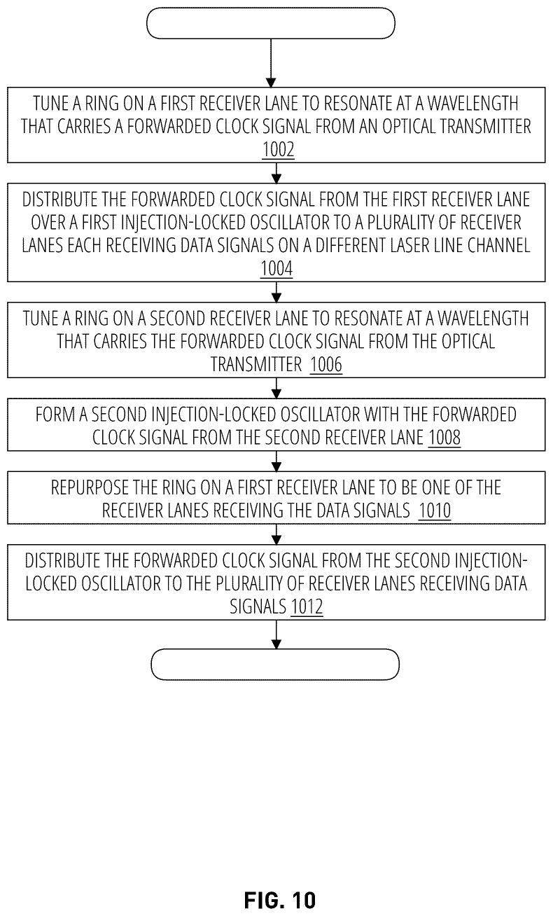

FIG. 10 depicts a dynamic wavelength re-assignment process in accordance with yet another embodiment. In block 1002, a ring on a first receiver lane is tuned to resonate at a wavelength that carries a forwarded clock signal from an optical transmitter. In block 1004, the forwarded clock signal from the first receiver lane is distributed over a first injection-locked oscillator to a plurality of receiver lanes each receiving data signals on a different laser line channel. In block 1006, a ring on a second receiver lane is tuned to resonate at a wavelength that carries the forwarded clock signal from the optical transmitter. In block 1008, a second injection-locked oscillator is formed with the forwarded clock signal from the second receiver lane. In block 1010, the ring on a first receiver lane is repurposed to be one of the receiver lanes receiving the data signals. In block 1012, the forwarded clock signal from the second injection-locked oscillator is distributed to the plurality of receiver lanes receiving data signals.

### LISTING OF DRAWING ELEMENTS

102 resonant ring
104 resonant ring
106 transmitter
108 receiver
110 waveguide
112 optical spectrum
114 laser source
302 optical resonator ring
402 transmitter
404 calibration logic
406 electrical conductor
408 electrical conductor
410 optical waveguide
412a modulator ring
412b modulator ring
412c modulator ring
414 receiver lane
416 DWDM laser source
502 receiver lane
602 direction
702 dummy load
704 lane receiver
706 electrical conductor
802 block
804 block
806 block
902 block
904 block
906 block
908 block
910 block
912 block
1002 block
1004 block
1006 block
1008 block
1010 block
1012 block

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device.

Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A method comprising:
deactivating a first optical resonator ring that is closest to a laser source along a waveguide from among a plurality of optical resonator rings along the waveguide, the first optical resonator ring tuned to a first laser wavelength;
deactivating a second optical resonator ring of the plurality of optical resonator rings, the second optical resonator ring tuned to a laser wavelength adjacent to the first laser wavelength; and
beginning with the first optical resonator ring, setting resonant wavelengths of the optical resonator rings sequentially in an order determined by a spectral ordering of the optical resonator rings along the waveguide.

2. A method comprising:
deploying a first inactive optical resonator ring and a plurality of active optical resonator rings along a waveguide;
deactivating one of the active optical resonator rings that is tuned to a first laser line wavelength, thus establishing a second inactive optical resonator ring;
setting a resonant wavelength of the second inactive optical resonator ring to a wavelength that is unused for channels on the waveguide;
setting a resonant wavelength of the first inactive optical resonator ring to the first laser line wavelength; and
activating the first inactive optical resonator ring on the waveguide.

3. The method of claim 2, wherein the resonant wavelength to which the second inactive optical resonator ring is tuned has a closest energy distance to one of the laser lines on the waveguide.

4. The method of claim 2, wherein deactivating the one of the active optical resonator rings that is tuned to the first laser line wavelength comprises:
re-tuning the resonant wavelength of the one of the active optical resonator rings to a wavelength that is not used for data or clock transmission on the waveguide.

5. A method comprising:
tuning a ring on a first receiver lane to resonate at a wavelength that carries a forwarded clock signal from an optical transmitter;
distributing the forwarded clock signal from the first receiver lane over a first injection-locked oscillator to a plurality of receiver lanes each receiving data signals on a different laser line channel;
tuning a ring on a second receiver lane to resonate at a wavelength that carries the forwarded clock signal from the optical transmitter;
forming a second injection-locked oscillator with the forwarded clock signal from the second receiver lane;
repurposing the ring on a first receiver lane to be one of the receiver lanes receiving the data signals; and
distributing the forwarded clock signal from the second injection-locked oscillator to the plurality of receiver lanes receiving data signals.

6. The method of claim 5, further comprising:
forming the first injection-locked oscillator on a first waveguide; and
forming the second injection-locked oscillator on a second waveguide.

7. An optical system comprising:
a laser source;
a waveguide optically coupled to the laser source;
a plurality of optical resonator rings arranged along the waveguide, the optical resonator rings comprising a first resonant ring tuned to a first wavelength of the laser source and a second resonant ring tuned to a second wavelength of the laser source adjacent to the first wavelength in an optical spectrum of the laser source, the first resonant ring positioned closest to the laser source along the waveguide;
logic configured to:
deactivate the first resonant ring;
deactivate the second resonant ring; and
beginning with the first resonant ring, setting resonant wavelengths of the optical resonator rings sequentially in an order determined by a spectral ordering of the optical resonator rings along the waveguide.

8. An optical system comprising:
a laser source configured to generate a plurality of laser lines;
a waveguide optically coupled to the laser source;
a plurality of optical resonator rings arranged along the waveguide;
logic configured to:
deactivate a first one of the optical resonator rings to establish a first inactive optical resonator ring;
deactivate a second one of the optical resonator rings that is tuned to a first one of the laser lines, to establish a second inactive optical resonator ring;
set a resonant wavelength of the second inactive optical resonator ring to an unused laser line;
set a resonant wavelength of the first inactive optical resonator ring to the first one of the laser lines; and
activate the first inactive optical resonator ring.

9. The optical system of claim 8, wherein the resonant wavelength to which the second inactive optical resonator ring is tuned has a closest energy distance to one of the laser lines on the waveguide.

10. The optical system of claim 8, wherein establishing the first inactive optical resonator ring comprises:
re-tuning a resonant wavelength of the first one of the optical resonator rings to a wavelength that is not used for data or clock transmission on the waveguide.

11. An optical system comprising:
an optical transmitter;
a plurality of receiver lanes coupled to the optical transmitter;
a first resonant ring optically coupled to a first one of the receiver lanes;
a second resonant ring optically coupled to a second one of the receiver lanes;
logic configured to:
tune the first resonant ring to resonate at a wavelength that carries a forwarded clock signal from the optical transmitter;
distribute the forwarded clock signal to receiver lanes other than the first one of the receiver lanes via a first injection-locked oscillator;
tune the second resonant ring to resonate at a wavelength that carries the forwarded clock signal from the optical transmitter;
form a second injection-locked oscillator with the forwarded clock signal from the second one of the receiver lanes;
re-tune the first resonant ring to receive data signals from the transmitter; and
distribute the forwarded clock signal from the second injection-locked oscillator to receiver lanes other than the second one of the receiver lanes.

12. The optical system of claim 11, wherein the first injection-locked oscillator is formed on a first waveguide and the second injection-locked oscillator is formed on a second waveguide.

13. The optical system of claim 11, wherein the logic is further configured to:
deactivate the first injection-locked oscillator subsequent to activating the second injection-locked oscillator.

14. A dense wave division multiplexed (DWDM) transceiver comprising:
a transmitter;
a receiver coupled to the transmitter over a waveguide;
a laser source configured to generate a plurality of laser lines;
the transmitter comprising a plurality of modulator rings, wherein a first of the modulator rings is configured to modulate a clock signal onto the waveguide at a first frequency corresponding to a first of the laser lines, and other of the modulator rings are configured to modulate data signals onto the waveguide;
the receiver comprising a plurality of resonant rings, wherein a first of the resonant rings is configured to resonate at the first frequency, and other of the resonant rings are configured to resonate at frequencies corresponding to the modulated data signals;
the receiver configured to:
distributing the clock signal from the first of the resonant rings over a first injection-locked oscillator to the other of the resonant rings;
tune a second of the resonant rings from one of the other of the resonant rings to resonate at the first frequency;
tune the first of the resonant rings to one of frequencies corresponding to the modulated data signals; and
distribute the clock signal from the second of the resonant rings over a second injection-locked oscillator.

15. The transceiver of claim 14, wherein the first injection-locked oscillator comprises a first waveguide and the second injection-locked oscillator comprises a second waveguide.

16. The transceiver of claim 14, wherein the receiver is further configured to:
deactivate the first injection-locked oscillator subsequent to activating the second injection-locked oscillator.

17. A dense wave division multiplexed (DWDM) transceiver comprising:
a transmitter;
a receiver coupled to the transmitter over a waveguide;
a laser source configured to generate a plurality of laser lines on the waveguide;
a plurality of modulator rings arranged along the waveguide;
logic configured to:
deactivate a first one of the modulator rings to establish a first inactive modulator ring;
deactivate a second one of the modulator rings that is tuned to a first one of the laser lines, to establish a second inactive modulator ring;
set a resonant wavelength of the second inactive modulator ring to an unused laser line;
set a resonant wavelength of the first inactive modulator ring to the first one of the laser lines; and
activate the first inactive modulator ring.

18. The transceiver of claim 17, wherein the resonant wavelength to which the second inactive modulator ring is tuned has a closest energy distance to one of the laser lines on the waveguide.

19. The transceiver of claim 17, wherein establishing the first inactive modulator ring comprises:
re-tuning a resonant wavelength of the first one of the modulator rings to a wavelength that is not used for data or clock transmission on the waveguide.

20. A dense wave division multiplexed (DWDM) transceiver comprising
a laser source;
a transmitter;
a receiver;
a waveguide optically coupled to the laser source and to the transmitter and to the receiver;
a plurality of modulator ring arranged along the waveguide, the modulator rings comprising a first modulator ring tuned to a first wavelength of the laser source and a second modulator ring tuned to a second wavelength of the laser source adjacent to the first wavelength in an optical spectrum of the laser source, the first modulator ring positioned closest to the laser source along the waveguide;
logic configured to:
deactivate the first modulator ring;
deactivate the second modulator ring; and
beginning with the first modulator ring, setting resonant wavelengths of the modulator rings sequentially in an order determined by a spectral ordering of the modulator rings along the waveguide.
